(19) United States
(12) Patent Application Publication
(10) Pub. No.: US 2014/0331871 A1
(43) Pub. Date: Nov. 13, 2014

(54) FOOD PROCESSOR

(71) Applicant: Ya Horng Electronic Co., Ltd., Tainan City (TW)

(72) Inventor: Jin-Yi HUANG, Tainan City (TW)

(73) Assignee: Ya Horng Electronic Co., Ltd., Tainan City (TW)

(21) Appl. No.: 14/087,687

(22) Filed: Nov. 22, 2013

(30) Foreign Application Priority Data
May 13, 2013 (CN) 201320257792.1

(51) Int. Cl. A23N 1/02

(52) U.S. Cl. CPC A23N 1/02
USPC 99/513; 99/510

(57) ABSTRACT

A food processor includes: a housing; a rotary processing body having a conical upper part and a lower part, the conical upper part being formed with a blade protruding therefrom, the lower part having an annular radial wall and an upright surrounding wall, the annular radial wall cooperating with the housing to define a processing clearance and being formed with first processing ribs that protrude therefrom into the processing clearance; and an annular filter cooperating with the upright surrounding wall to define a processing gap. The upright surrounding wall is formed with second processing ribs that protrude therefrom into the processing gap.

### CROSS-REFERENCE TO RELATED APPLICATION

This application claims priority of Chinese Application No. 201320257792.1, filed on May 13, 2013.

### BACKGROUND OF THE INVENTION

1. Field of the Invention

This invention relates to a food processor, more particularly to a food processor including a rotary processing body that is formed with a blade and processing ribs.

2. Description of the Related Art

Conventional food processors are useful for extracting juice from food. A conventional food processor normally includes a housing and a cutter member that is disposed rotatably in the housing and that is provided with a blade for cutting the food into residue and juice which are then separated from each other using a filter.

### SUMMARY OF THE INVENTION

An object of the present invention is to provide a rotary processing body that can provide cutting and squeezing functions.

Another object of the present invention is to provide a food processor that can provide cutting and squeezing functions.

According to one aspect of this invention, there is provided a rotary processing body for a food processor. The rotary processing body comprises: a conical upper part; and a lower part that extends from and that is coaxially disposed below the conical upper part. The conical upper part is formed with a blade protruding therefrom. The lower part has an annular radial wall and an upright surrounding wall. The annular radial wall radiates from the conical upper part, and is formed with spaced apart first processing ribs that protrude therefrom. The upright surrounding wall extends downwardly from the annular radial wall, cooperates with the annular radial wall to define an annular corner therebetween, and is formed with spaced apart second processing ribs that protrude therefrom.

According to another aspect of this invention, there is provided a food processor that comprises: a housing defining an accommodating space therein; a rotary processing body supported rotatably in the accommodating space, rotatable relative to the housing about a rotation axis, and having a conical upper part and a lower part, the conical upper part cooperating with the housing to define a grinding space therebetween and being formed with a blade protruding therefrom into the grinding space, the lower part having an annular radial wall and an upright surrounding wall, the annular radial wall radiating from the conical upper part toward the housing, cooperating with the housing to define a processing clearance therebetween, and being formed with spaced apart first processing ribs that protrude therefrom into the processing clearance, the upright surrounding wall extending downwardly from the annular radial wall and cooperating with the annular radial wall to define an annular corner therebetween; and an annular filter disposed between the housing and the upright surrounding wall and cooperating with the upright surrounding wall to define a processing gap therebetween. The upright surrounding wall is formed with spaced apart second processing ribs that protrude therefrom into the processing gap.

### BRIEF DESCRIPTION OF THE DRAWINGS

In drawings which illustrate an embodiment of the invention,

FIG. 1 is a perspective view of the preferred embodiment of a food processor according to the present invention;

FIG. 2 is another perspective view of the preferred embodiment, viewed from another angle;

FIG. 3 is an exploded perspective view of the preferred embodiment;

FIG. 4 is another exploded perspective view of the preferred embodiment;

FIG. 5 is a top view of a middle seat of the preferred embodiment;

FIG. 6 is a fragmentary sectional view of the preferred embodiment;

FIG. 7 is a fragmentary enlarged sectional view of the preferred embodiment;

FIG. 8 is a sectional view of a top cover of the preferred embodiment;

FIG. 9 is a bottom view of the top cover of the preferred embodiment;

FIG. 10 is a perspective view of a rotary processing body of the preferred embodiment; and

FIG. 11 is an exploded sectional view of the rotary processing body and the middle seat of the preferred embodiment.

### DETAILED DESCRIPTION OF THE PREFERRED EMBODIMENT

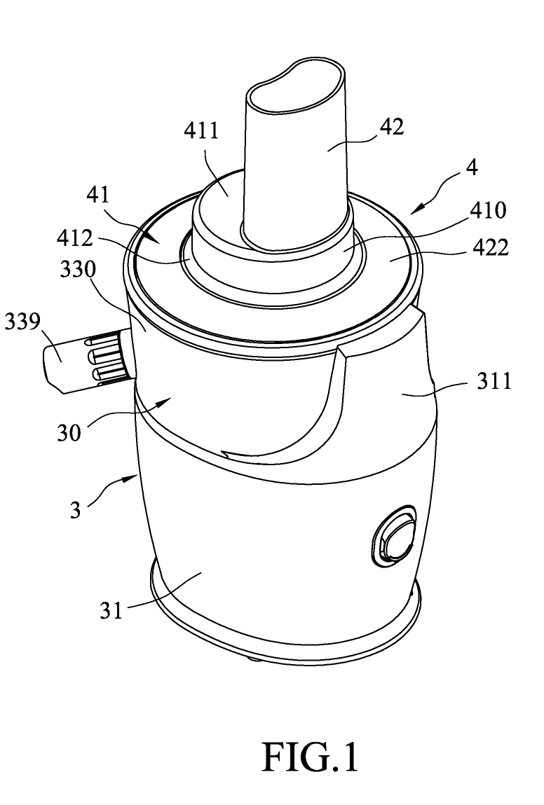

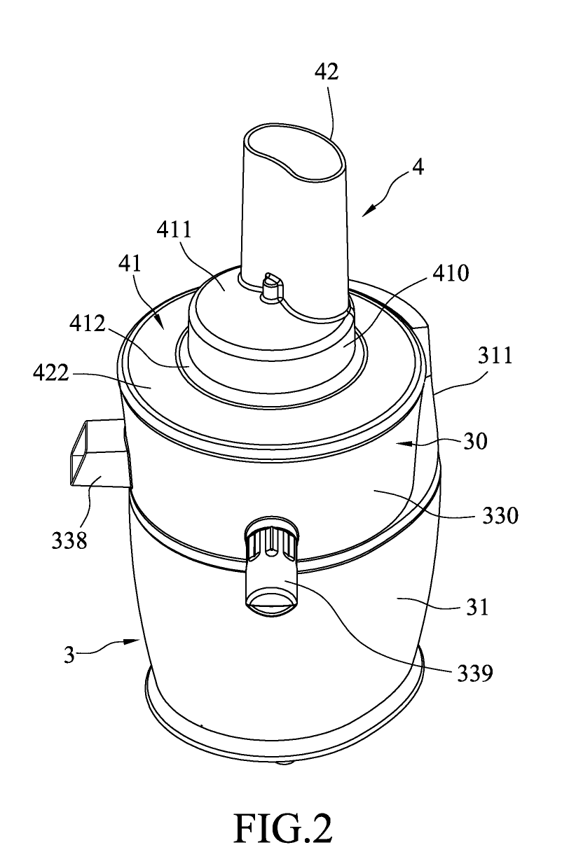

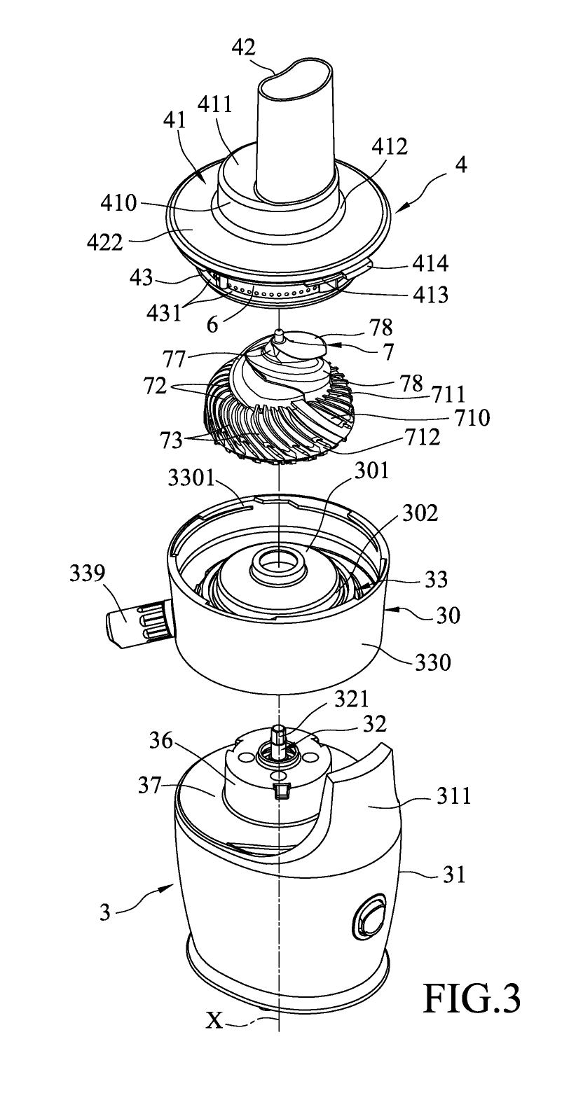

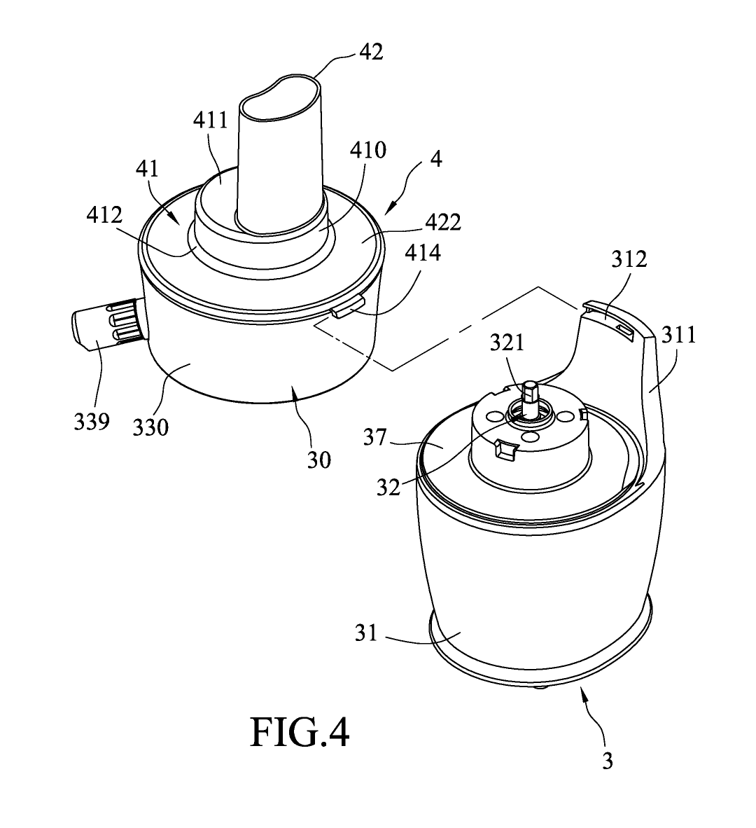

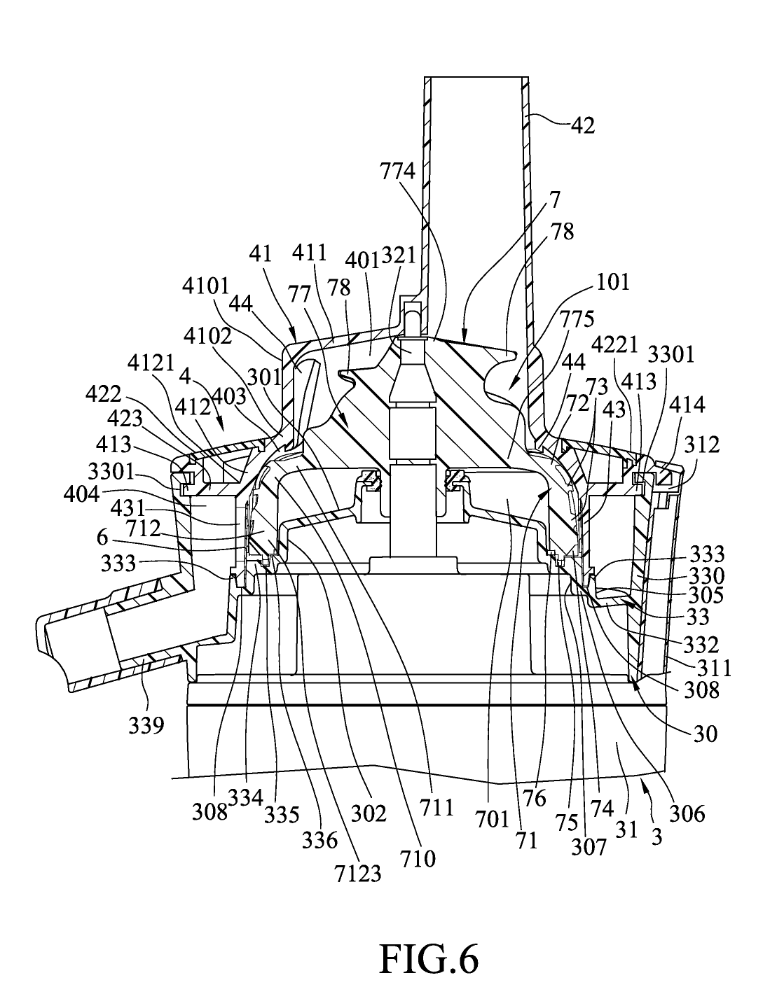

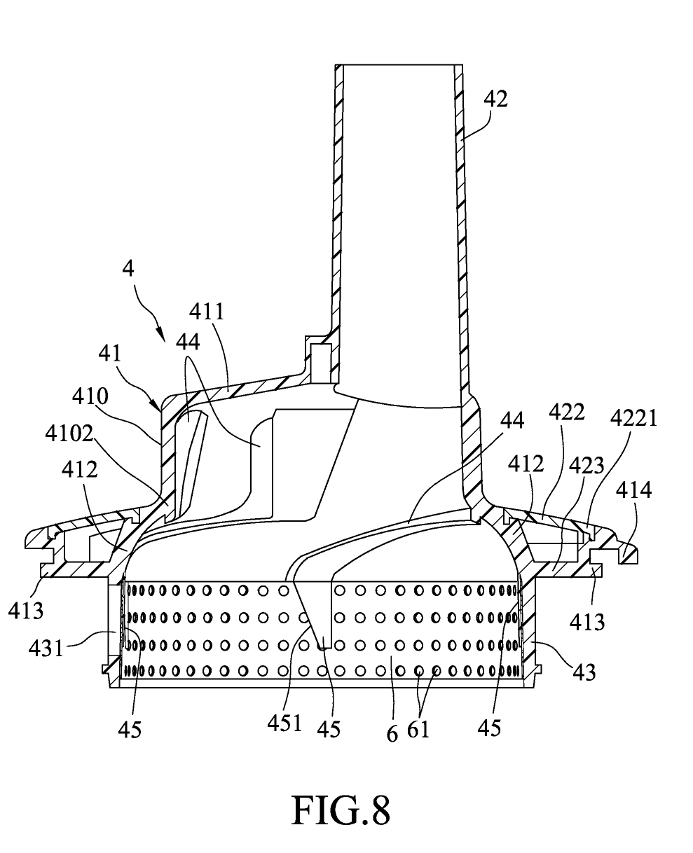

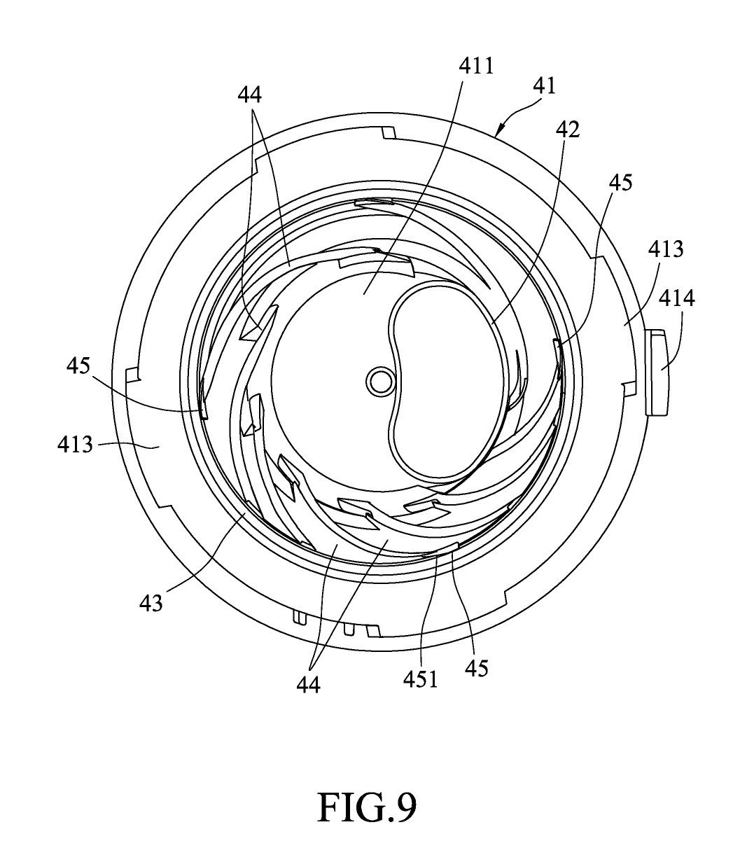

FIGS. 3 and 6, in combination with FIGS. 1, 2, 4, 5 and 7 to 11, illustrate the preferred embodiment of a food processor for cutting and squeezing food according to the present invention. The food processor includes a base seat 3, a housing 4, a driving unit 32, a filter 6, and a rotary processing body 7.

The base seat 3 has a shell wall 31, a top plate 37, a cylindrical projection 36 that protrudes from the top plate 37, and a vertical mounting wall 311 which extends upwardly from the top plate 37 and which is formed with an engaging recess 312.

The driving unit 32 is mounted to the base seat 3, and is disposed in the shell wall 31. In this embodiment, the driving unit 3 is a motor having an output shaft 321 that extends upwardly and outwardly through a top end of the cylindrical projection 36 and that defines a rotation axis (X).

The housing 4 defines an accommodating space 101 therein, and includes a hollow middle seat 30 and a top cover 41 that is seated on and that cooperates with the middle seat 30 to define the accommodating space 101.

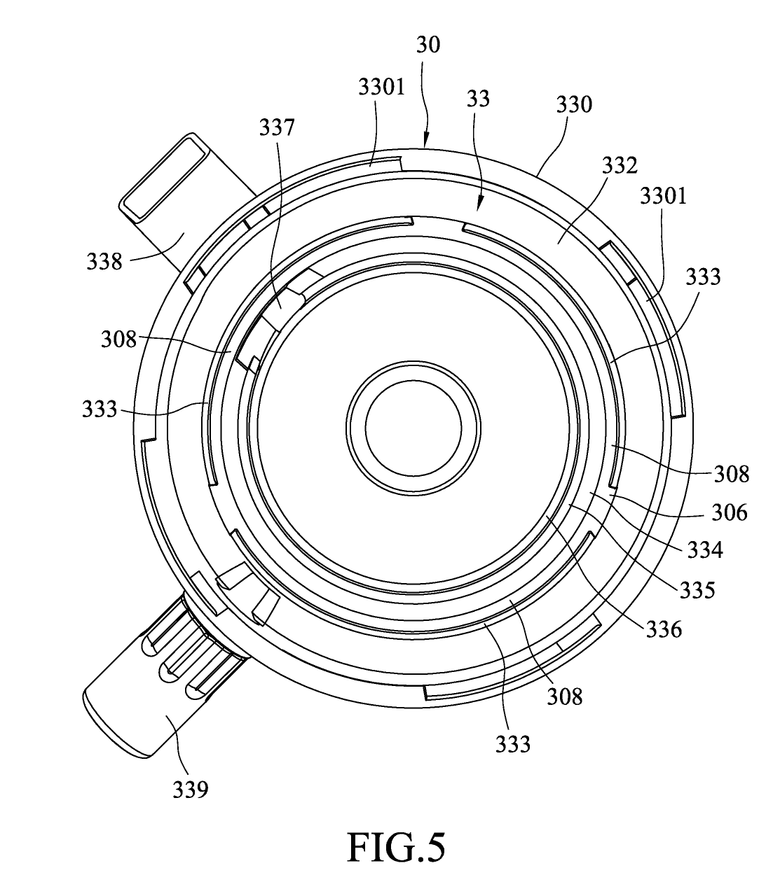

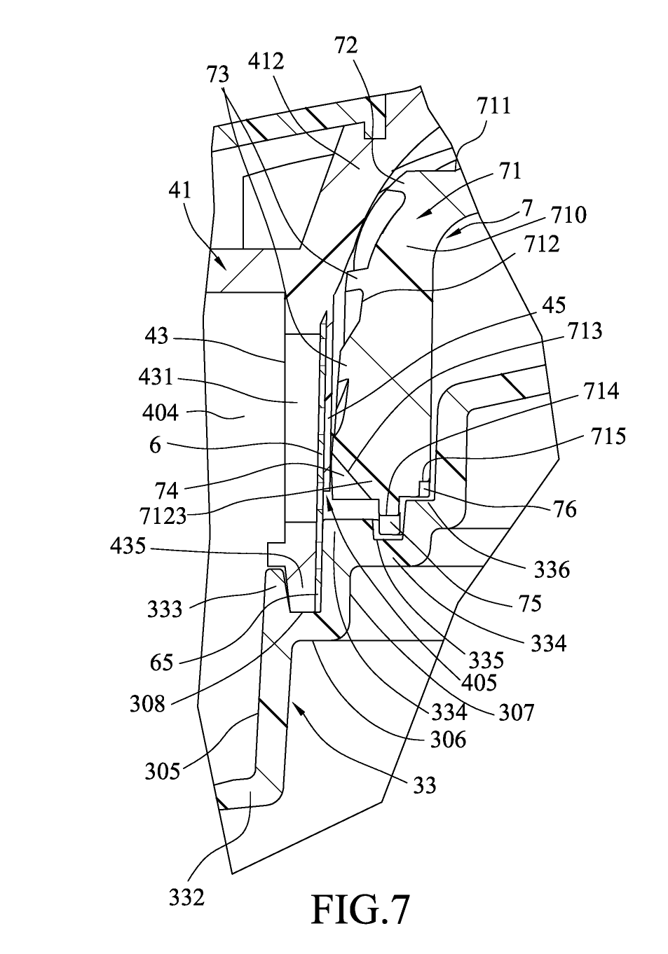

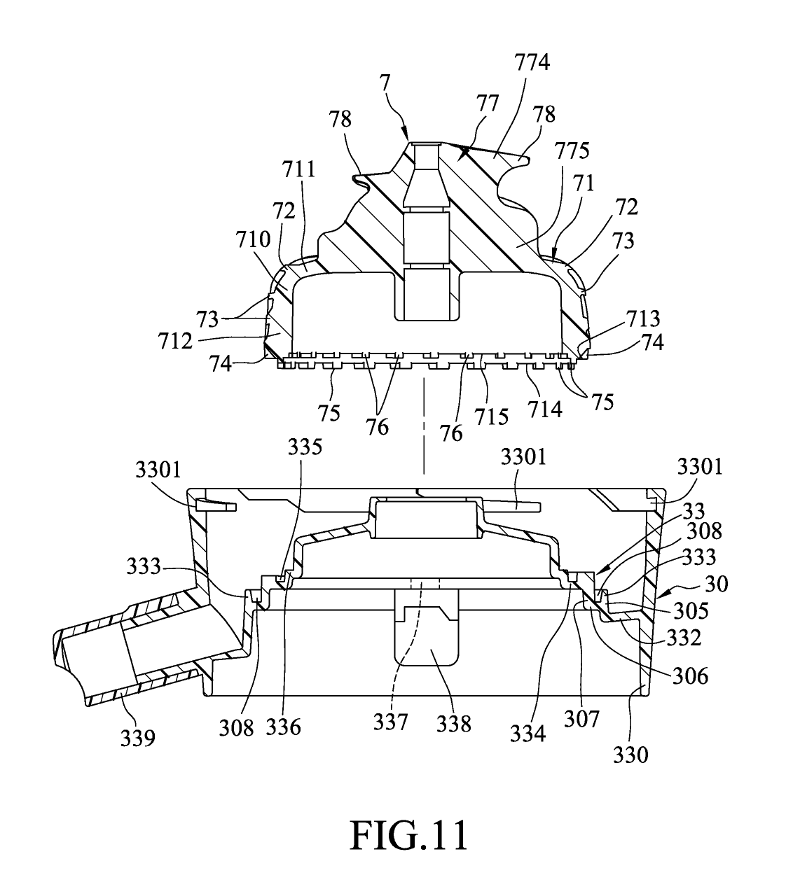

The middle seat 30 is seated on the top plate 37, and has an outer surrounding wall 330, a fluid discharging tube 339, a residue discharging tube 338, an annular central wall 301, an inner tubular wall 302, an annular stepped wall 33, and a top end that is formed with a plurality of retaining grooves 3301. The fluid discharging tube 339 extends outwardly from the outer surrounding wall 330. The inner tubular wall 302 is coaxially surrounded by the outer surrounding wall 330, and extends between and interconnects the annular stepped wall 33 and the annular central wall 301. Referring to FIGS. 7 and 11, the annular stepped wall 33 extends between and interconnects the outer surrounding wall 330 and the inner tubular wall 302, and has a first step portion 332, a first riser portion 305 that extends upwardly from the first step portion 332, and a second step portion 334 that is disposed above the first step portion 332 and that is disposed between the first step portion 332 and the rotation axis (X). The annular stepped wall 33 further has a middle step portion 306 that radiates from the first riser portion 305 and that is disposed between the first and second step portions 332, 334, a second riser portion 307 that extends between the middle step portion 306 and the second step portion 334, and a plurality of restricting protrusions 333 that are angularly displaced from one another and that extend upwardly from a top end of the first riser portion 305. The restricting protrusions 333 cooperate with the middle step portion 306 and the second riser portion 307 to define a plurality restricting grooves 308, respectively. A residue outlet hole 337 is formed in the second step portion 334 of the annular stepped wall 33 (see FIG. 5). The residue discharging tube 338 is connected to a periphery of the residue outlet hole 337, is in fluid communication with the residue outlet hole 337, and extends outwardly therefrom through the outer surrounding wall 330.

The top cover 41 covers a top opening of the middle seat 30, and has a top wall 411, a cylindrical wall 410 that extends downwardly from the top wall 411, a skirt wall 412 that flares downwardly from a bottom end 4102 of the cylindrical wall 410 into the middle seat 30, a lower annular frame 43 that extends downwardly from the skirt wall 412 into the middle seat 30 and that defines a plurality of openings 431, an annular upper flange wall 422 that radiates outwardly from an upper end of the skirt wall 412 and that has a peripheral end which is formed with an engaging tongue 414, and an annular lower flange wall 423 that radiates outwardly from a lower end of the skirt wall 412 and that has a peripheral end which is formed with a plurality of protrusions 413. An inlet tube 42 extends upwardly from the top wall 411. The engaging tongue 414 engages detachably the engaging recess 312. The protrusions 413 engage the retaining grooves 3301, respectively. The lower annular frame 43 has a lower portion 435 extending into the restricting grooves 308 (see FIG. 7). The annular filter 6 is detachably attached to an inner side of the lower annular frame 43, and has a lower portion 65 extending into the restricting grooves 308. The outer surrounding wall 330 surrounds and cooperates with the annular filter 6 and the annular stepped wall 33 to define a fluid channel 404 that is in fluid communication with the fluid discharging tube 339. The first step portion 332 cooperates with the first riser portion 305 and the outer surrounding wall 330 to define a lower section of the fluid channel 404, and is inclined gradually and downwardly from one end thereof to the other end that is disposed adjacent to the fluid discharging tube 339.

The rotary processing body 7 is a single piece, is supported rotatably in the accommodating space 101, is rotatable relative to the housing 4 about the rotation axis (X), and has a conical upper part 77 and a lower part 71 that extends from and that is coaxially disposed below the conical upper part 77. The conical upper part 77 has top and bottom ends 774, 775 and an axis that overlaps the rotation axis (X), cooperates with the top wall 411 and the cylindrical wall 410 to define a grinding space 401 thereamong, and is formed with a plurality of blades 78 protruding therefrom into the grinding space 401 for grinding food passing through the grinding space 401. The lower part 71 has an annular radial wall 711 and an upright surrounding wall 712. The annular radial wall 711 radiates outwardly from the bottom end 775 of the conical upper part 77 toward the top cover 41 of the housing 4, and cooperates with the skirt wall 412 to define a processing clearance 403 therebetween. The upright surrounding wall 712 extends downwardly from the annular radial wall 711, is coaxially surrounded by the lower annular frame 43, and cooperates with the annular radial wall 711 to define an annular corner 710 therebetween. The processing clearance 403 has top and bottom ends, flares downwardly from a lower end of the grinding space 401, and when viewed in a cross-section, is tapered from the top end to the bottom end of the processing clearance 403. The driving unit 32 is connected to the conical upper part 77 of the rotary processing body 7 for driving rotation of the rotary processing body 7 about the rotation axis (X). The blades 78 extend helically around the rotation axis (X) from the top end 774 to the bottom end 775 of the conical upper part 77.

The annular filter 6 is disposed between the lower annular frame 43 and the upright surrounding wall 712, and cooperates with the upright surrounding wall 712 to define a processing gap 405 therebetween. The annular filter 6 is formed with apertures 61 so as to permit fluid communication between the processing gap 405 and the fluid channel 404 via the apertures 61. The residue outlet hole 337 is in fluid communication with the processing gap 405.

The annular radial wall 711 is formed with a plurality of spaced apart first processing ribs 72 that protrude therefrom into the processing clearance 403, that are angularly displaced from one another, and that extend curvedly from the lower end 775 of the conical upper part 77 to the annular corner 710. The upright surrounding wall 712 is formed with a plurality of spaced apart second processing ribs 73 that protrude therefrom into the processing gap 405, that are angularly displaced from one another, and that extend downwardly and inclinedly relative to the rotation axis (X) from the first processing ribs 72, respectively, to a lower end portion of the upright surrounding wall 712.

In this embodiment, the top cover 41 surrounds the conical upper part 77 and the lower part 71, and is formed with a plurality of processing fins 44 protruding therefrom into the grinding space 401 and the processing clearance 403 so as to cooperate with the blades 78 and the first processing ribs 72 to grind and squeeze food passing through the grinding space 401 and the processing clearance 403. The processing fins 44 extend downwardly and inclinedly relative to the rotation axis (X) from a top end 4101 of the cylindrical wall 410 to a lower end 4121 of the skirt wall 412.

The processing gap 405 has top and bottom ends, and when viewed in a cross-section, is tapered from the top end to the bottom end of the processing gap 405. The top cover 41 is further formed with a plurality of guiding plates 45 that are angularly displaced from one another. Each of the guiding plates 45 extends downwardly from a lower end of a respective one of the processing fins 44 into the processing gap 405, is disposed between the annular filter 6 and the upright surrounding wall 712, and has an inclined side 451 that extends downwardly and inclinedly relative to the rotation axis (X) from the lower end of the respective one of the processing fins 44 for guiding residue of the food entering the processing gap 405.

In this embodiment, the upright surrounding wall 712 has a bottom end portion 7123 that has an annular inclined face 713 which is inclined relative to the rotation axis (X) and which faces toward the annular filter 6 and the second step portion 334. The bottom end portion 7123 of the upright surrounding wall 712 is formed with a plurality of residue-pushing tabs 74 that protrude downwardly from the annular inclined face 713 toward the annular filter 6 and the second step portion 334 and that are angularly displaced from one another.

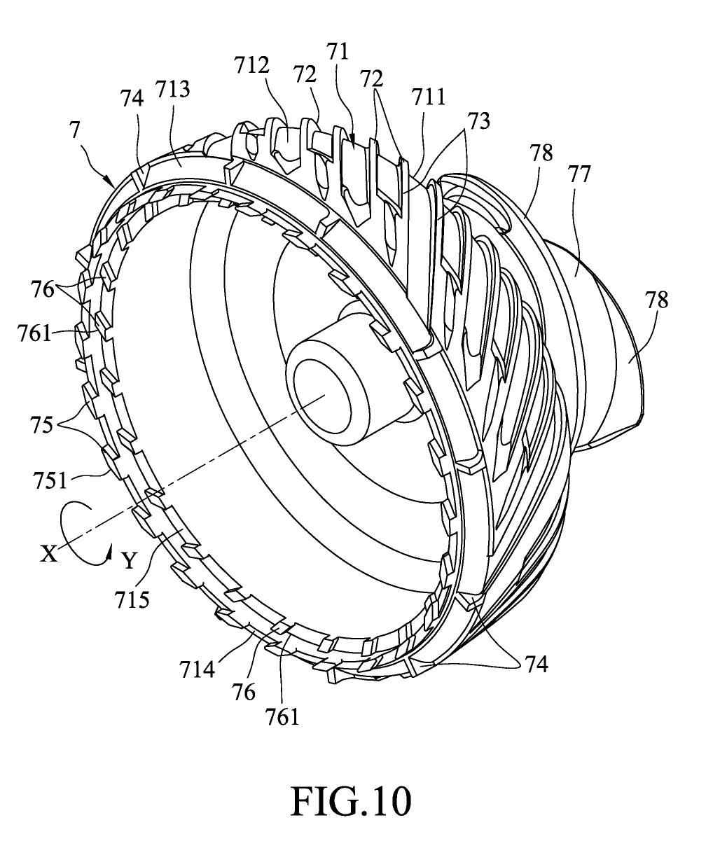

The second step portion 334 is formed with an annular residue-guiding trough 335 indented downwardly therefrom and in fluid communication with the residue outlet hole 337. The bottom end portion 7123 of the upright surrounding wall 712 further has an annular middle face 714 that is disposed below and inwardly of the annular inclined face 713, that extends in a radial direction relative to the rotation axis (X), and that faces toward the residue-guiding trough 335, and is further formed with a plurality of first teeth 75 that are angularly displaced from one another and that extend downward from the annular middle face 714 into the residue-guiding trough 335. Each of the first teeth 75 has an inclined side 751 that extends outwardly and inclinedly relative to the radial direction in a backward direction against a rotational direction (Y) of the rotary processing body 7 (see FIG. 10).

The annular stepped wall 33 further has a third step portion 336 that is disposed above the second step portion 334 and between the second step portion 334 and the rotation axis (X). The bottom end portion 7123 of the upright surrounding wall 712 further has an annular inner face 715 that is disposed above and inwardly of the annular middle face 714 and that extends in the radial direction, and is further formed with a plurality of second teeth 76 that are angularly displaced from one another and that extend downward from the annular inner face 715 toward the third step portion 336. Each of the second teeth 76 has an inclined side 761 that extends outwardly and inclinedly relative to the radial direction in the backward direction against the rotational direction (Y) of the rotary processing body 7.

In operation, the rotary processing body 7 is rotated in the rotational direction (Y) by the driving unit 32 and food is fed into the grinding space 401 through the inlet tube 42. Upon rotation, the blades 78 cooperate with the processing fins 44 to cut the food into small pieces, to squeeze juice from the food and to guide the pieces of the food and the juice to slide into the processing clearance 403. The pieces of the food in the processing clearance 403 are subsequently squeezed and crushed and are guided together with the juice into the processing gap 405 by the processing fins 44 and the first processing ribs 72 that cooperate with the processing fins 44 to perform the cutting and squeezing. Since the processing gap 405 is tapered downwardly when viewed in a cross section, the second processing ribs 73 cooperate with the annular filter 6 to further squeeze and crush the pieces of the food to reduce the sizes of the pieces of the food in the processing gap 405 and to extract more juice out of the same. The squeezed juice is accumulated in the processing gap 405, and is caused to flow through the apertures 61 in the annular filter 6 into the fluid channel 404 and then into the fluid discharging tube 339, thereby separating the squeezed juice from the pieces of the food in the processing gap 405. The inclined sides 451 of the guiding plates 45 cooperate with the second processing ribs 73 to guide the pieces of the food, which become residue, in the processing gap 405 to fall downwardly, such that residue is accumulated both on the second step portion 334 of the annular stepped wall 33 and in the residue-guiding trough 335. Driven by the rotation of the rotary processing body 7, the residue-pushing tabs 74 sweep the residue on the second step portion 334 into the residue outlet hole 337 and the inclined sides 751 of the first teeth 75 sweep the residue in the residue-guiding trough 335 into the residue outlet hole 337, thereby permitting discharging of the residue into and through the residue discharging tube 338. In addition, the third step portion 336 of the annular stepped wall 33, which has a height greater than that of the second step portion 334, prevents the residue from moving into an inner space 701 defined by an inner surface of the rotary processing body 7, the annular central wall 301 and the inner tubular wall 302. The inclined side 761 of the second teeth 76 push the residue that moves upwardly from the residue-guiding trough 335 toward the third step portion 336 back into the residue-guiding trough 335.

In this embodiment, each of the first and second processing ribs 72, 73 has a strip shape. Alternatively, each of the first and second processing ribs 72, 73 can have a bar or block shape.

With the inclusion of the rotary processing body 7 and the processing fins 44 in the food processor of the present invention, food can be cut and squeezed into tiny pieces to extract juice.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A rotary processing body for a food processor, comprising:
a conical upper part; and
a lower part that extends from and that is coaxially disposed below said conical upper part, said conical upper part being formed with a blade protruding therefrom, said lower part having an annular radial wall and an upright surrounding wall, said annular radial wall radiating from said conical upper part and being formed with spaced apart first processing ribs that protrude therefrom, said upright surrounding wall extending downwardly from said annular radial wall, cooperating with said annular radial wall to define an annular corner therebetween, and being formed with spaced apart second processing ribs that protrude therefrom.

2. The rotary processing body of claim 1, wherein said conical upper part has top and bottom ends, said blade extending helically around an axis of said conical upper part from said top end to said bottom end of said conical upper part.

3. The rotary processing body of claim 1, wherein said upright surrounding wall has a bottom end portion that has an annular inclined face which is inclined relative to the axis of said conical upper part, and that is formed with a plurality of residue-pushing tabs that protrude downwardly from said annular inclined face and that are angularly displaced from one another.

4. The rotary processing body of claim 3, wherein said bottom end portion of said upright surrounding wall further has an annular middle face that is disposed below and inwardly of said annular inclined face and that extends in a radial direction relative to the axis of said upper conical part, and is further formed with a plurality of first teeth that are angularly displaced from one another and that extend downward from said annular middle face, each of said first teeth having an inclined side that is inclined to the radial direction.

5. The rotary processing body of claim 4, wherein said bottom end portion further has an annular inner face that is disposed above and inwardly of said annular middle face and that extends in the radial direction, and is further formed with a plurality of second teeth that are angularly displaced from one another and that extend downward from said annular inner face, each of said second teeth having an inclined side that is inclined to the radial direction.

6. A food processor comprising:
a housing defining an accommodating space therein;
a rotary processing body supported rotatably in said accommodating space, rotatable relative to said housing about a rotation axis, and having a conical upper part and a lower part, said conical upper part cooperating with said housing to define a grinding space therebetween and being formed with a blade protruding from said conical upper part into said grinding space, said lower part having an annular radial wall and an upright surrounding wall, said annular radial wall radiating from said conical upper part toward said housing, cooperating with said housing to define a processing clearance therebetween, and being formed with spaced apart first processing ribs that protrude therefrom into said processing clearance, said upright surrounding wall extending downwardly from said annular radial wall and cooperating with said annular radial wall to define an annular corner therebetween; and
an annular filter disposed between said housing and said upright surrounding wall and cooperating with said upright surrounding wall to define a processing gap therebetween;
wherein said upright surrounding wall is formed with spaced apart second processing ribs that protrude therefrom into said processing gap.

7. The food processor of claim 6, wherein said housing includes a hollow middle seat and a top cover that is seated on said hollow middle seat and that cooperates with said middle seat to define said accommodating space, that surrounds said conical upper part and said lower part, that cooperates with said annular radial wall to define said processing clearance, and that is formed with a plurality of processing fins protruding therefrom into said grinding space and said processing clearance so as to cooperate with said blade and said first processing ribs to grind and squeeze food passing through the grinding space and the processing clearance.

8. The food processor of claim 6, wherein said conical upper part has top and bottom ends, said blade extending helically around the rotation axis from said top end to said bottom end of said conical upper part.

9. The food processor of claim 7, further comprising an inlet tube, said top cover having a top wall, a cylindrical wall that extends downwardly from said top wall, and a skirt wall that flares downwardly from said cylindrical wall, said inlet tube extending upwardly from said top wall, said cylindrical wall cooperating with said top wall and said conical upper part to define said grinding space, said skirt wall cooperating with said annular radial wall to define said processing clearance, said processing clearance having top and bottom ends, flaring downwardly from a lower end of said grinding space, and being tapered from said top end to said bottom end of said processing clearance when viewed in a cross-section, said processing fins extending downwardly and inclinedly relative to the rotation axis from a top end of said cylindrical wall to a lower end of said skirt wall.

10. The food processor of claim 9, wherein said first processing ribs extend curvedly, said second processing ribs extending downwardly and inclinedly relative to the rotation axis from said first processing ribs, respectively.

11. The food processor of claim 10, wherein said top cover further has a lower annular frame that extends downwardly from said skirt wall, that surrounds coaxially said upright surrounding wall of said lower part, and that defines a plurality of openings, said annular filter being disposed between said lower annular frame and said upright surrounding wall and being attached to said lower annular frame.

12. The food processor of claim 11, wherein said processing gap has top and bottom ends, and when viewed in a cross-section, is tapered from said top end to said bottom end of said processing gap, said top cover being further formed with a plurality of guiding plates that are angularly displaced from one another, each of said guiding plates extending downwardly from a lower end of a respective one of said processing fins into said processing gap, being disposed between said annular filter and said upright surrounding wall, and having an inclined side that extends downwardly and inclinedly relative to the rotation axis from said lower end of the respective one of said processing fins for guiding residue of the food entering said processing gap.

13. The food processor of claim 11, further comprising a driving unit and a base seat that has a top plate and a vertical mounting wall which extends upwardly from said top plate and which is formed with an engaging recess, said driving unit being mounted to said base seat, said middle seat being seated on said top plate, said top cover further having an annular upper flange wall that radiates outwardly from said skirt wall and that has a peripheral end, said peripheral end of said annular flange wall being formed with an engaging tongue that engages detachably said engaging recess.

14. The food processor of claim 13, wherein said hollow middle seat has an outer surrounding wall, a fluid discharging tube that extends outwardly from said outer surrounding wall, an inner tubular wall that is surrounded by said outer surrounding wall, and an annular stepped wall that extends between said outer surrounding wall and said inner tubular wall, said outer surrounding wall surrounding and cooperating with said annular filter and said annular stepped wall to define a fluid channel therebetween, said fluid discharging tube being in fluid communication with said fluid channel, said annular filter being disposed between said fluid channel and said processing gap and permitting fluid communication between said processing gap and said fluid channel, said annular stepped wall being formed with a residue outlet hole that is in fluid communication with said processing gap.

15. The food processor of claim 14, wherein said annular stepped wall has a first step portion, a first riser portion that extends upwardly from said first step portion, and a second step portion that is disposed above said first step portion and that is disposed between said first step portion and the rotation axis, said residue outlet hole being formed in said second step portion, said first step portion cooperating with said first riser portion and said outer surrounding wall to define a lower section of said fluid channel.

16. The food processor of claim 15, wherein said annular stepped wall further has a middle step portion that radiates from said first riser portion and that is disposed between said first and second step portions, a second riser portion that extends between said middle step portion and said second step portion, and a plurality of restricting protrusions that are angularly displaced from one another and that extend upwardly from a top end of said first riser portion, said restricting protrusions cooperating with said middle step portion and said second riser portion to define a plurality restricting grooves, respectively, said lower annular frame having a lower portion extending into said restricting grooves, said upright surrounding wall having a bottom end portion that has an annular inclined face which is inclined relative to the rotation axis and which faces toward said annular filter and said second step portion, said bottom end portion of said upright surrounding wall being formed with a plurality of residue-pushing tabs that protrude downwardly from said annular inclined face toward said annular filter and said second step portion and that are angularly displaced from one another.

17. The food processor of claim 16, wherein said second step portion is formed with an annular residue-guiding trough indented downwardly therefrom, said bottom end portion of said upright surrounding wall further having an annular middle face that is disposed below and inwardly of said annular inclined face, that extends in a radial direction relative to the rotation axis, and that faces toward said residue-guiding trough, and being further formed with a plurality of first teeth that are angularly displaced from one another and that extend downward from said annular middle face into said residue-guiding trough, each of said first teeth having an inclined side that is inclined to the radial direction relative to the rotation axis.

18. The food processor of claim 17, wherein said annular stepped wall further has a third step portion that is disposed above said second step portion and between said second step portion and the rotation axis, said bottom end portion of said upright surrounding wall further having an annular inner face that is disposed above and inwardly of said annular middle face and that extends in the radial direction, and being further formed with a plurality of second teeth that are angularly displaced from one another and that extend downward from said annular inner face toward said third step portion, each of said second teeth having an inclined side that is inclined to the radial direction.
